(19) United States
(12) Patent Application Publication
(10) Pub. No.: US 2019/0348941 A1
(43) Pub. Date: Nov. 14, 2019

(54) ELECTRIC-MOTOR DRIVING APPARATUS, REFRIGERATION CYCLE APPARATUS, AND AIR CONDITIONER

(71) Applicant: Mitsubishi Electric Corporation, Tokyo (JP)

(72) Inventors: Koichi ARISAWA, Tokyo (JP); Shinya TOYODOME, Tokyo (JP); Shigeo UMEHARA, Tokyo (JP)

(21) Appl. No.: 16/349,328

(22) PCT Filed: Nov. 24, 2016
(86) PCT No.: PCT/JP2016/084783

§ 371 Date: May 13, 2019

(51) Int. Cl. H02P 25/18; H02P 27/08; H02M 7/537; F25B 31/02

(52) U.S. Cl. CPC H02P 25/188; F25B 31/02; H02M 7/537; H02P 27/08

(57) ABSTRACT

An electric-motor driving apparatus is used to drive an electric motor including a plurality of winding groups constituting a three-phase winding. The electric-motor driving apparatus includes a switch that switches connection of windings of a first winding group and a second winding group, an inverter that drives an electric motor, and a controller that controls the inverter and the switch.

### CROSS REFERENCE TO RELATED APPLICATION

This application is a U.S. national stage application of International Patent Application No. PCT/JP2016/084783 filed on Nov. 24, 2016, the disclosure of which is incorporated herein by reference.

### TECHNICAL FIELD

The present invention relates to an electric-motor driving apparatus that drives an electric motor including a plurality of winding groups constituting a three-phase winding, a refrigeration cycle apparatus, and an air conditioner.

### BACKGROUND

Patent Literature 1 discloses a method for driving a three-phase electric motor including two sets of three-phase windings in which neutral points of the two sets of three-phase windings are not connected.

In addition, Patent Literature 2 discloses a method for driving an electric motor including four winding groups using four inverters.

Furthermore, Patent Literature 3 discloses a method for driving an electric motor, in which a plurality of windings are connected in series, with two inverters.

### PATENT LITERATURE

Patent Literature 1: Japanese Patent No. 3938486

Patent Literature 2: Japanese Patent No. 5230250

Patent Literature 3: Japanese Patent Application Laid-open No. 2013-121222

### Technical Problem

In recent years, electric motors including a plurality of winding groups as disclosed in Patent Literatures 1 to 3 have been used. Such electric motors have advantages for applications having large output capacities, but can be disadvantageous in the efficiency for applications having small output capacities.

In addition, such electric motors have room for improvement in the efficiency in low-speed regions and the low-current regions although they are used in applications having large output capacities. For this reason, improvement in the system efficiency in the low speed regions and the low current regions has been required.

### SUMMARY

The present invention has been made in view of the above, and an object thereof is to provide an electric-motor driving apparatus, a refrigeration cycle apparatus, and an air conditioner which are capable of improving the system efficiency in a low speed region and a low current region.

To solve the above problems and achieve the object an electric-motor driving apparatus according to the present invention is used to drive an electric motor that includes a plurality of winding groups constituting a three-phase winding. The electric-motor driving apparatus includes: a switch switching connection of windings of the winding groups; at least one inverter to drive the electric motor; and a controller to control the inverter and the switch.

According to the present invention, it is possible to improve the system efficiency in a low speed region and a low current region.

### BRIEF DESCRIPTION OF DRAWINGS

FIG. 1 is a block diagram illustrating a configuration example of a refrigeration cycle apparatus according to a first embodiment.

FIG. 2 is a circuit diagram illustrating a configuration of an electric-motor driving system including an electric-motor driving apparatus according to the first embodiment.

FIG. 3 is a circuit diagram illustrating a detailed configuration of an inverter and a switch in the electric-motor driving apparatus according to the first embodiment.

FIG. 4 is a diagram illustrating a different connection state between the inverter and the switch from the connection state in FIG. 3.

FIG. 5 is a circuit diagram illustrating a configuration of an electric-motor driving system including an electric-motor driving apparatus according to a second embodiment.

FIG. 6 is a circuit diagram illustrating a detailed configuration of an inverter and a switch in the electric-motor driving apparatus according to the second embodiment.

FIG. 7 is a diagram illustrating a different connection state between inverter groups and the switch from the connection state in FIG. 6.

FIG. 8 is a block diagram illustrating an example of a hardware configuration that implements a controller according to first embodiment and second embodiment.

FIG. 9 is a block diagram illustrating another example of a hardware configuration that implements the controller according to first embodiment and second embodiment.

### DETAILED DESCRIPTION

Hereinafter, an electric-motor driving apparatus, a refrigeration cycle apparatus, and an air conditioner according to embodiments of the present invention are described in detail with reference to the drawings. Note that, the present invention is not limited by the following embodiments.

### First Embodiment

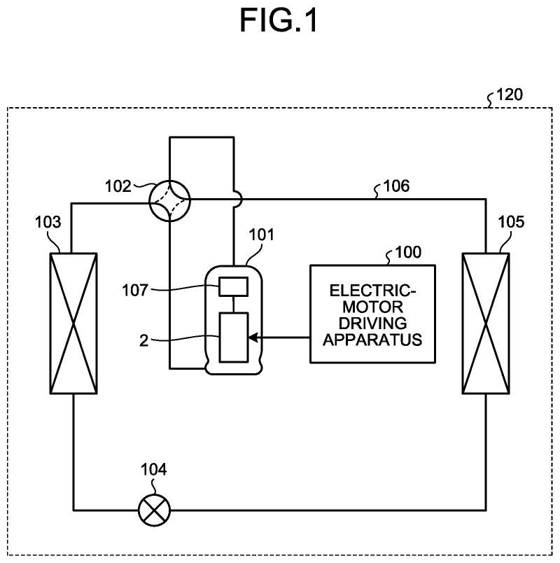

FIG. 1 is a block diagram illustrating a configuration example of a refrigeration cycle apparatus according to a first embodiment. A refrigeration cycle apparatus 120 illustrated in FIG. 1 is an application example of an electric-motor driving apparatus according to the first embodiment and a second embodiment to be described later. FIG. 1 exemplifies a separate-type air conditioner, but the air conditioner is not limited to the separate type. In addition, although the refrigeration cycle apparatus 120 that constitutes an air conditioner is described as an example in the present embodiment, the refrigeration cycle apparatus 120 is not limited to an air conditioner and is applicable to an apparatus having a refrigeration cycle such as a refrigerator and a freezer.

As illustrated in FIG. 1, the refrigeration cycle apparatus 120 in the present embodiment includes a compressor 101, a four-way valve 102, an outdoor heat exchanger 103, an expansion valve 104, an indoor heat exchanger 105, a refrigerant pipe 106, and an electric-motor driving apparatus 100. In the refrigeration cycle apparatus 120, a refrigeration cycle is constituted by attaching the compressor 101, the four-way valve 102, the outdoor heat exchanger 103, and the expansion valve 104 and the indoor heat exchanger 105 via the refrigerant pipe 106. Inside the compressor 101 of the refrigeration cycle apparatus 120, a compression mechanism 107 that compresses a refrigerant, and an electric motor 2 that operates the compression mechanism 107 are provided. The electric motor 2 of the compressor 101 is electrically connected to the electric-motor driving apparatus 100. The electric-motor driving apparatus 100 is used to drive the electric motor 2 used in the compressor 101 that compresses the refrigerant.

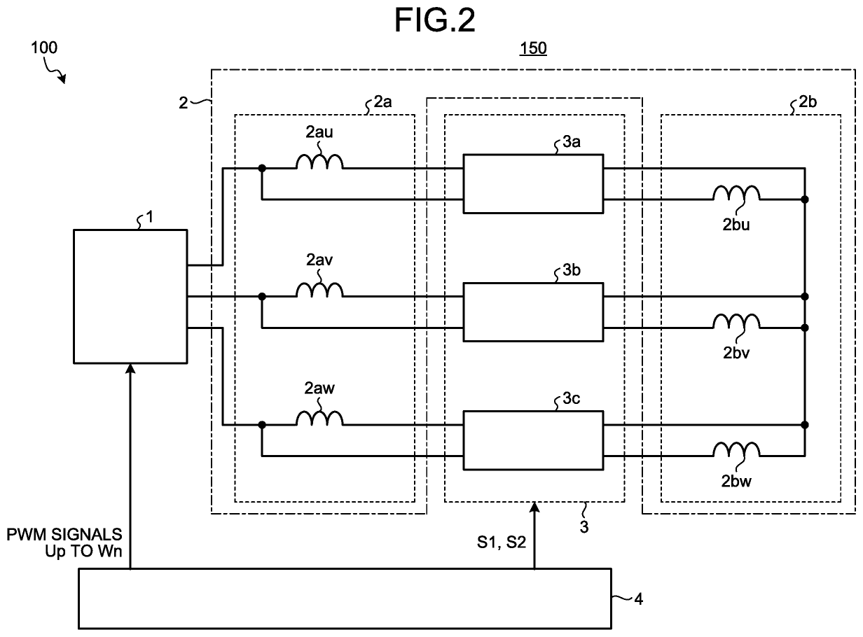

FIG. 2 is a circuit diagram illustrating a configuration of an electric-motor driving system 150 including the electric-motor driving apparatus 100 according to the first embodiment. The electric-motor driving system 150 includes the electric-motor driving apparatus 100 and the electric motor 2 to be driven by the electric-motor driving apparatus 100. The electric-motor driving apparatus 100 includes an inverter 1, a switch 3, and a controller 4.

In FIG. 2, the electric motor 2 includes a U-phase first winding 2au, a V-phase first winding 2av, a W-phase first winding 2aw, a U-phase second winding 2bu, a V-phase second winding 2bv, and a W-phase second winding 2bw. The U-phase first winding 2au, the V-phase first winding 2av, and the W-phase first winding 2aw constitute a first winding group 2a. The U-phase second winding 2bu, the V-phase second winding 2bv, and the W-phase second winding 2bw constitute a second winding group 2b.

FIG. 2 exemplifies two winding groups of the first winding group 2a and the second winding group 2b, but the number of winding groups may be three or more. That is, the electric motor 2 is an electric motor including a plurality of winding groups constituting a three-phase winding.

A pair of the U-phase first winding 2au and the U-phase second winding 2bu is referred to as a U-phase winding portion. Similarly, a pair of the V-phase first winding 2av and the V-phase second winding 2bv is referred to as a V-phase winding portion, and a pair of the W-phase first winding 2aw and the W-phase second winding 2bw is referred to as a W-phase winding portion. FIG. 2 exemplifies a three-phase winding portion in which the U-phase winding portion, the V-phase winding portion, and the W-phase winding portion each including two windings, but each winding portion may include three or more windings. That is, the electric motor 2 is a three-phase electric motor including the U-phase winding portion including a plurality of U-phase windings, the V-phase winding portion including a plurality of V-phase windings, and a W-phase winding portion including a plurality of W-phase windings.

The electric-motor driving apparatus 100 according to the first embodiment is characterized by a connection mode between the electric motor 2 and the switch 3 and the control of the switch 3 by the controller 4. For this reason, illustration of sensors for acquiring the electric-motor current flowing through the electric motor 2 is omitted. In order to acquire the electric-motor current, by providing a shunt resistor inside the inverter 1 without directly detecting the current flowing through the electric motor 2, three-phase currents may be detected from the current flowing through the shunt resistor. When the load is in an equilibrium state, the fact that the sum of the three phase currents is zero may be used to obtain the third phase current from the first phase current and the second phase current. Regarding the control of the electric motor 2 using the electric motor current, there are many well-known techniques, and the explanation thereof is omitted in this description.

The switch 3 is interposed between the first winding group 2a and the second winding group 2b. The switch 3 includes a switching group 3a, a switching group 3b, and a switching group 3c. The connections between the first winding group 2a and the switching groups 3a, 3b and 3c, and between the second winding group 2b and the switching groups 3a, 3b, and 3c will be described later.

The inverter 1 is electrically connected to the first winding group 2a. PWM signals Up to Wn generated by the controller 4 are output to the inverter 1. The PWM signals are pulse width modulation signals which are well known in this field. The inverter 1 is controlled by the PWM signals Up to Wn input from the controller 4 and supplies power to each phase of the first winding group 2a. The inverter 1 further supplies power to each phase of the second winding group 2b via the first winding group 2a and the switch 3.

The controller 4 generates switching signals S1 and S2 for controlling the switching groups 3a, 3b, and 3c.

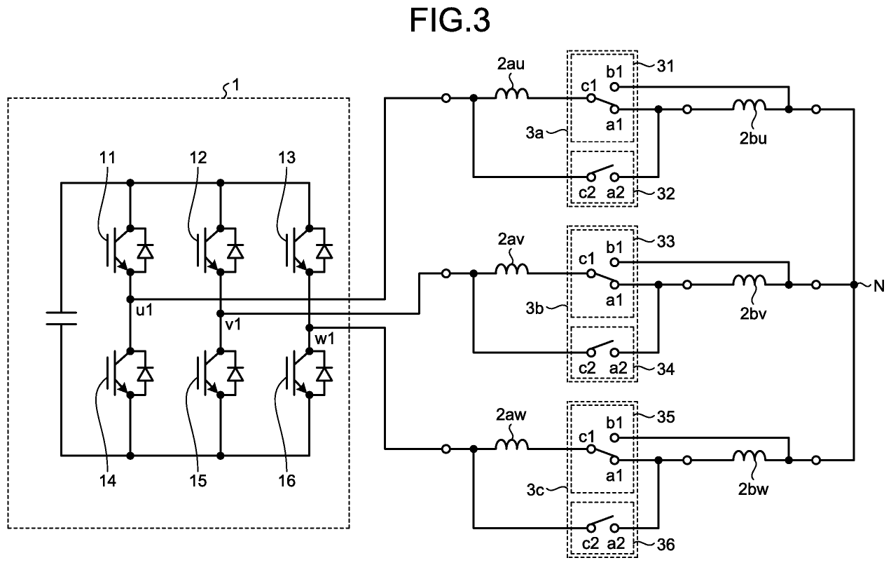

Next, a configuration of the inverter 1 and the switch 3 is described with reference to FIG. 3. FIG. 3 is a circuit diagram illustrating a detailed configuration of the inverter 1 and the switch 3 in the electric-motor driving apparatus 100 according to the first embodiment.

In FIG. 3, the inverter 1 includes switching elements 11 to 16. The switching elements 11 to 13 constitute switching elements of upper arms, and the switching elements 14 to 16 constitute switching elements of lower arms. The upper-arm switching element 11 and the lower-arm switching element 14 are connected in series to form a pair of U-phase switching elements. Similarly, the upper-arm switching element 12 and the lower-arm switching element 15 are connected in series to form a pair of V-phase switching elements, and the upper-arm switching element 13 and the lower-arm switching element 16 are connected in series to form a pair of W-phase switching elements.

A connection point u1 of the upper-arm switching element 11 and the lower-arm switching element 14 is drawn to the outside of the inverter 1 and connected to one end of the U-phase first winding 2au. A connection point v1 of the upper-arm switching element 12 and the lower-arm switching element 15 is drawn to the outside of the inverter 1 and connected to one end of the V-phase first winding lay. A connection point w1 of the upper-arm switching element 13 and the lower-arm switching element 16 is drawn to the outside of the inverter 1 and connected to one end of the W-phase first winding 2aw.

Next, the switching groups 3a, 3b, and 3c are described. The switching group 3a includes a first switch 31 and a second switch 32. The first switch 31 is a switch having a single-pole double-throw function, and the second switch 32 is a switch having a single-pole single-throw function. The switching group 3b includes a third switch 33 and a fourth switch 34. The third switch 33 is a switch having a single-pole double-throw function, and the fourth switch 34 is a switch having a single-pole single-throw function. The switching group 3c includes a fifth switch 35 and a sixth switch 36. The fifth switch 35 is a switch having a single-pole double-throw function, and a sixth switch 36 is a switch having a single-pole single-throw function.

Each of the first switch 31, the third switch 33, and the fifth switch 35 has switching contacts a1 and b1 and a base point c1. Each of the second switch 32, the fourth switch 34, and the sixth switch 36 has a contact a2 and a base point c2.

Each of the first switch 31, the second switch 32, the third switch 33, the fourth switch 34, the fifth switch 35, and the sixth switch 36 may be a mechanical switch or an electrical switch. In the case of an electrical switch, a switch called a semiconductor relay or a power relay is preferable. With a semiconductor relay or a power relay, it is possible to vary the time required for switching the connection.

Next, connections between the switching groups 3a, 3b, and 3c, the first winding group 2a, the second winding group 2b, and the inverter 1 are described.

The base point c1 of the first switch 31 is connected to the other end of the U-phase first winding 2au. The switching contact a1 of the first switch 31 is connected to one end of the U-phase second winding 2bu. The switching contact b1 of the first switch 31 is connected to the other end of the U-phase second winding 2bu. The base point c2 of the second switch 32 is connected to the connection point of the one end of the U-phase first winding 2au and the connection point u1 of the U-phase switching elements 11 and 14. The contact a2 of the second switch 32 is connected to the connection point of the switching contact a1 of the first switch 31 and the one end of the U-phase second winding 2bu.

The base point c1 of the third switch 33 is connected to the other end of the V-phase first winding 2av. The switching contact a1 of the third switch 33 is connected to one end of the V-phase second winding 2bv.

The switching contact b1 of the third switch 33 is connected to the other end of the V-phase second winding 2bv. The base point c2 of the fourth switch 34 is connected to the connection point of the one end of the V-phase first winding 2av and the connection point v1 of the V-phase switching elements 12 and 15. The contact a2 of the fourth switch 34 is connected to the connection point of the switching contact a1 of the third switch 33 and the one end of the V-phase second winding 2bv.

The base point c1 of the fifth switch 35 is connected to the other end of the W-phase first winding 2aw. The switching contact a1 of the fifth switch 35 is connected to one end of the W-phase second winding 2bw. The switching contact b1 of the fifth switch 35 is connected to the other end of the W-phase second winding 2bw. The base point c2 of the sixth switch 36 is connected to the connection point of the one end of the W-phase first winding 2aw and the connection point w1 of the W-phase switching elements 13 and 16. The contact a2 of the sixth switch 36 is connected to the connection point of the switching contact a1 of the fifth switch 35 and the one end of the W-phase second winding 2bw.

The other end of the U-phase second winding 2bu, the other end of the V-phase second winding 2bv, and the other end of the W-phase second winding 2bw are connected to each other to constitute a neutral point N of the electric motor 2. As apparent from the configuration in FIG. 3, regardless of how the switching contacts a1 and b1 and the contact a2 of the switching groups 3a, 3b, and 3c are switched, the connection state of the neutral point N of the electric motor 2 is maintained without being changed.

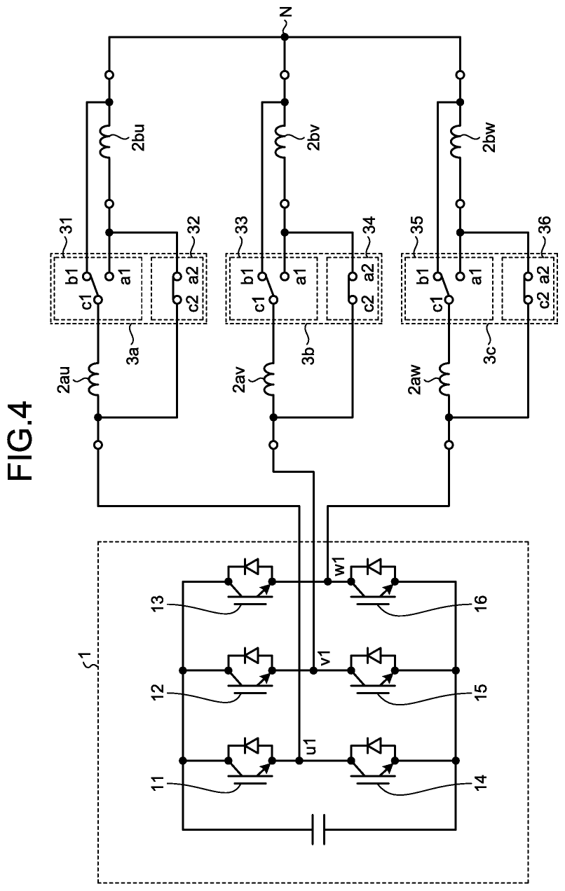

Next, the operation of the main part of the electric-motor driving apparatus 100 according to first embodiment is described with reference to FIGS. 2 to 4. FIG. 4 is a diagram illustrating a different connection state between the inverter 1 and the switch 3 from the connection state in FIG. 3.

First, the controller 4 outputs a changeover signal S1 to the switch 3. Inside the switch 3 at this time, a signal for switching the first switch 31, the third switch 33, and the fifth switch 35 to the switching contact a1 sides, and a signal for switching the contacts of the second switch 32, the fourth switch 34, and the sixth switch 36 to be opened are generated. By these signals, the switching contacts of the first switch 31, the third switch 33, and the fifth switch 35 are switched to the switching contact a1 sides, and the contacts of the second switch 32, the fourth switch 34, and the sixth switch 36 are switched to be opened.

In the connection state illustrated in FIG. 3, the serial-winding electric motor 2 is configured by connecting the U-phase first winding 2au and connecting the U-phase second winding 2bu in series, the V-phase first winding 2av and the V-phase second winding 2bv in series, and connecting the W-phase first winding 2aw and the W-phase second winding 2bw in series.

Alternatively, the controller 4 outputs a switching signal S2 to the switch 3. Inside the switch 3 at this time, a signal for switching the first switch 31, the third switch 33, and the fifth switch 35 to the switching contact b1 sides, and a signal for switching the contacts of the second switch 32, the fourth switch 34, and the sixth switch 36 to be closed are generated. By these signals, the switching contacts of the first switch 31, the third switch 33, and the fifth switch 35 are switched to the switching contact b1 sides, and the contacts of the second switch 32, the fourth switch 34, and the sixth switch 36 are switched to be closed. FIG. 4 is a diagram illustrating the connection state at this time.

In the connection state illustrated in FIG. 4, the parallel-winding electric motor 2 is configured by connecting the U-phase first winding 2au and the U-phase second winding 2bu in parallel, connecting the V-phase first winding 2av and the V-phase second winding 2bv in parallel, and connecting the W-phase first winding 2aw and the W-phase second winding 2bw in parallel. Also in the connection state of FIG. 4, the state in which the neutral point N of the electric motor 2 is connected is maintained.

As described above, by outputting the switching signal S1 from the controller 4 to the switch 3, it is possible to change the winding specification of the electric motor 2 from the parallel winding to the serial winding by each phase. In addition, by outputting the switching signal S2 from the controller 4 to the switch 3, it is possible to change the winding specification of the electric motor 2 from the serial winding to the parallel winding by each phase. By changing the winding specification of the electric motor 2 from the serial winding to the parallel winding by each phase, it is possible to vary the inductance between the lines in the electric motor 2 or the resistance value between the lines. In addition, by changing the winding specification of the electric motor 2 from the serial winding to the parallel winding by each phase, it is possible to vary the phase induced voltage or the line induced voltage to be induced in the electric motor 2.

Furthermore, when the control is performed to change the winding specification of the electric motor 2 from the parallel winding to the serial winding or from the serial winding to the parallel winding, the switching signal for the switch 3 is one signal as described above. Then, the respective contacts of the first switch 31, the second switch 32, the third switch 33, the fourth switch 34, the fifth switch 35, and the sixth switch 36 are controlled by the signals inside the switch 3, and it is possible to perform the connection switching at an arbitrary timing.

When the winding specification of the electric motor 2 is the serial winding, the inductance value and the impedance value of the winding are larger than those in the case of the parallel winding. Thus, when the winding specification of the electric motor 2 is the serial winding, the induced voltage to be induced in the winding of the electric motor 2 increases as compared with those in the case of the parallel winding. Accordingly, when the electric motor 2 is driven under the condition of the same rotation speed or the same output, the induced voltage can be increased as long as the electric motor 2 is configured by the serial winding, and it is possible to suppress the peak value of the electric current.

Alternatively, when the winding specification of the electric motor 2 is the parallel winding, it is possible to suppress the induced voltage of the winding as compared with that in the case of the serial winding. Thus, it is possible to decrease the induced voltage in a high speed region as long as the electric motor 2 is configured by the parallel winding. In addition, regardless the connection is the serial winding or the parallel winding, there is no unused winding, and it is possible to effectively utilize the windings.

As described above, with the electric-motor driving apparatus 100 according to the first embodiment, it is possible for the switch 3 to switch the connection state of the windings of the electric motor 2. Thus, it is possible to switch the connection state of the windings of the electric motor 2 depending on the rotation speed of the electric motor 2. Specifically, it is possible to change the winding specification of the electric motor 2 to the serial winding as the rotation speed decreases, or to change the winding specification of the electric motor 2 to the parallel winding as the rotation speed increases. By performing the control in this manner, it is possible to improve the system efficiency in a low speed region where the rotation speed is low, that is, in a low load region.

The rotation speed of the electric motor 2 is equivalent to the inverter frequency which is the frequency of the voltage applied by the inverter 1 to the electric motor 2. That is, the electric-motor driving apparatus 100 may switch the connection state of the windings of the electric motor 2 depending on the inverter frequency of the electric motor 2.

In the above example of controlling, it has been described that the connection state of the electric motor 2 is switched depending on the rotation speed of the electric motor 2. However, the connection state of the windings of the electric motor 2 may be switched depending on the modulation rate when the inverter 1 is controlled. Specifically, the control is performed to change the winding specification of the electric motor 2 to the serial winding as the modulation rate decreases, or to change the winding specification of the electric motor 2 to the parallel winding as the modulation rate increases. Thus, it is possible to improve the system efficiency in a low current region where the rotational torque is small, that is, in a low load region.

In addition, as another example of controlling, the connection state of the electric motor 2 may be switched depending on the operation mode of the electric motor 2. In the case of an air conditioner, the operation mode includes, for example, a compression operation mode in which the compressor compresses the refrigerant, a heating operation mode in which the compressor is heated, a cooling operation mode in which the compressor is used for the cooling operation, and a heating operation mode in which the compressor is used for the heating operation.

In the above example in FIG. 3, it has been described that the number of windings constituting each phase winding portion, that is, the U-phase winding portion, the V-phase winding portion, and the W-phase winding portion of the electric motor 2 is two. However, the number of windings of each phase winding portion may be three or more. By adding switches equivalent to the first switch 31 and the second switch 32 in FIG. 3 for newly added windings, it is possible to freely switch the serial connection, the parallel connection, or the serial/parallel connection of the windings.

### Second Embodiment

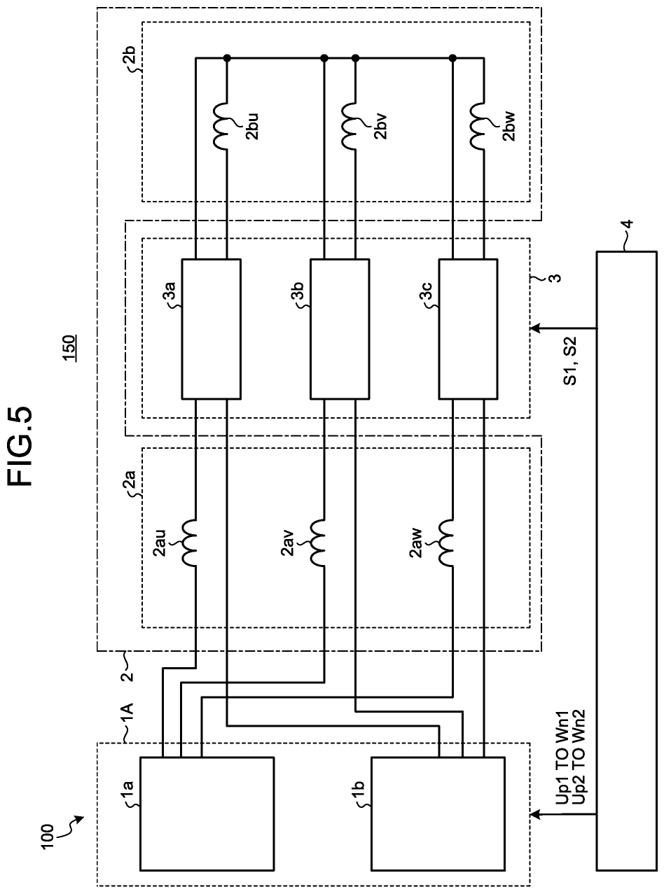

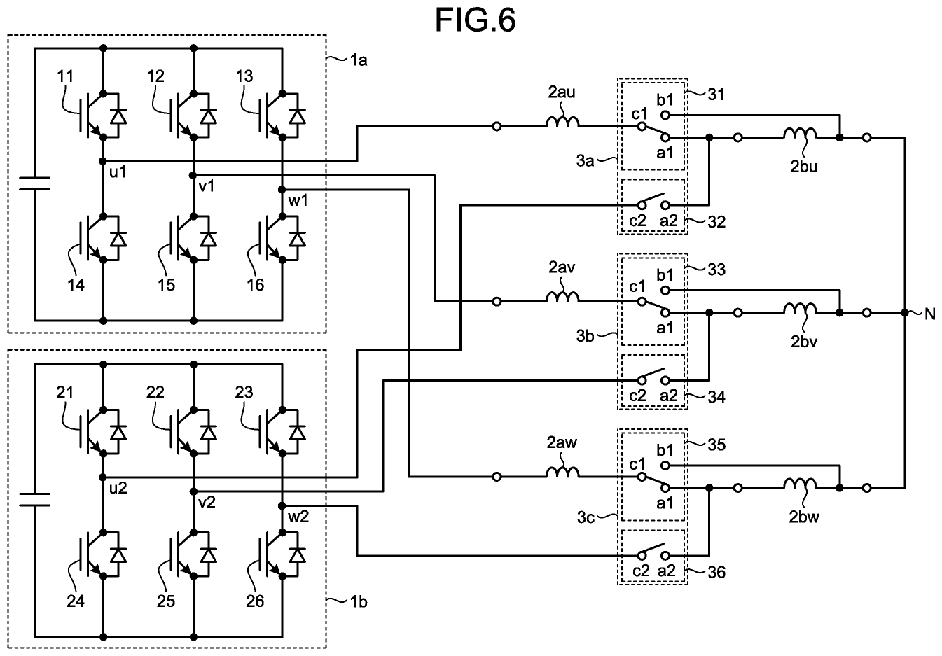

FIG. 5 is a circuit diagram illustrating a configuration of the electric-motor driving system 150 including the electric-motor driving apparatus 100 according to a second embodiment. FIG. 6 is a circuit diagram illustrating a detailed configuration of inverters 1a and 1b and the switch 3 in the electric-motor driving apparatus 100 according to the second embodiment. The differences of the electric-motor driving apparatus 100 according to the second embodiment from the electric-motor driving apparatus 100 in the first embodiment is that the electric motor 2 is driven by an inverter group 1A including two inverters 1a and 1b, the connection configuration between the switch 3 and the inverters 1a and 1b, the connection configuration between the switch 3 and the electric motor 2. Hereinafter, these differences are mainly described. Note that, the same reference signs are assigned to the same or equivalent parts as the parts of the first embodiment illustrated in FIG. 2, and redundant explanation is omitted as appropriate.

First, the inverter 1a is equivalent to the inverter 1 illustrated in FIG. 3, and the description thereof is omitted.

As illustrated in FIG. 6, the inverter 1b includes switching elements 21 to 26. The switching elements 21 to 23 constitute switching elements of upper arms, and the switching elements 24 to 26 constitute switching elements of lower arms. The upper-arm switching element 21 and the lower-arm switching element 24 are connected in series to form a pair of U-phase switching elements. Similarly, the upper-arm switching element 22 and the lower-arm switching element 25 are connected in series to form a pair of V-phase switching elements, and the upper-arm switching element 23 and the lower-arm switching element 26 are connected in series to form a pair of W-phase switching elements.

The base point c1 of the first switch 31 is connected to the other end of the U-phase first winding 2au.

The switching contact a1 of the first switch 31 is connected to one end of the U-phase second winding 2bu. The switching contact b1 of the first switch 31 is connected to the other end of the U-phase second winding 2bu. The base point c2 of the second switch 32 is connected to a connection point u2 of the U-phase switching elements 21 and 24 of the inverter 1b. The contact a2 of the second switch 32 is connected to the connection point of the switching contact a1 of the first switch 31 and the one end of the U-phase second winding 2bu. As described above, the connection form of the base point c2 of the second switch 32 is different from the connection form in the first embodiment.

The base point c1 of the third switch 33 is connected to the other end of the V-phase first winding lay. The switching contact a1 of the third switch 33 is connected to one end of the V-phase second winding 2bv. The switching contact b1 of the third switch 33 is connected to the other end of the V-phase second winding 2bv. The base point c2 of the fourth switch 34 is connected to a connection point v2 of the V-phase switching elements 22 and 25 of the inverter 1b. The contact a2 of the fourth switch 34 is connected to the connection point of the switching contact a1 of the third switch 33 and the one end of the V-phase second winding 2bv. As described above, the connection form of the base point c2 of the fourth switch 34 is different from the connection form in the first embodiment.

The base point c1 of the fifth switch 35 is connected to the other end of the W-phase first winding 2aw. The switching contact a1 of the fifth switch 35 is connected to one end of the W-phase second winding 2bw. The switching contact b1 of the fifth switch 35 is connected to the other end of the W-phase second winding 2bw. The base point c2 of the sixth switch 36 is connected to a connection point w2 of the W-phase switching elements 23 and 26 of the inverter 1b. The contact a2 of the sixth switch 36 is connected to the connection point of the switching contact a1 of the fifth switch 35 and the one end of the W-phase second winding 2bw. As described above, the connection form of the base point c2 of the sixth switch 36 is different from the connection form in the first embodiment.

The other end of the U-phase second winding 2bu, the other end of the V-phase second winding 2bv, and the other end of the W-phase second winding 2bw are connected to each other to constitute a neutral point N of the electric motor 2. This configuration is similar to the configuration in the first embodiment. As apparent from the configuration in FIG. 6, regardless of how the switching contacts and the contacts of the switching groups 3a, 3b, and 3c are switched, the connection state of the neutral point N of the electric motor 2 is maintained without being changed. This point is also similar to that in the first embodiment.

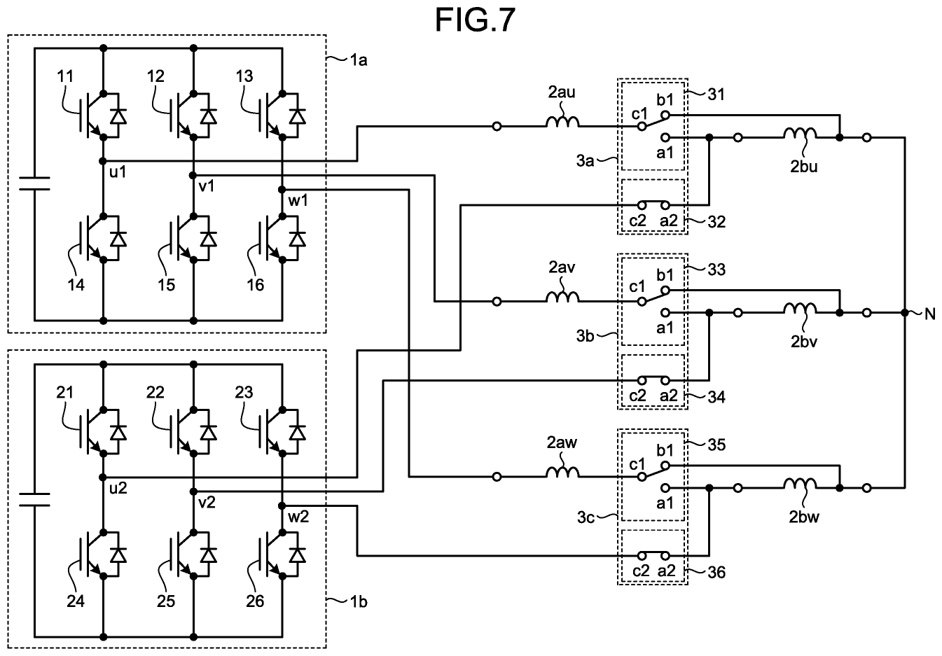

Next, the operation of the main part of the electric-motor driving apparatus 100 according to the second embodiment is described with reference to FIGS. 5 to 7 FIG. 7 is a diagram illustrating a different connection state between the inverter group 1A and the switch 3 from the connection state in FIG. 6.

As illustrated in FIG. 5, PWM signals Up1 to Wn1 and Up2 to Wn2 generated by the controller 4 are output to the inverter group 1A. The inverter 1a is controlled by the PWM signals Up1 to Wn1 from the controller 4 and supplies power to each phase of the first winding group 2a. The inverter 1a further supplies power to each phase of the second winding group 2b via the first winding group 2a and the switch 3 depending on the connection state of the switch 3. On the other hand, the inverter 1b is controlled by the PWM signals Up2 to Wn2 from the controller 4 and supplies power to each phase of the second winding group 2b depending on the connection state of the switch 3.

The controller 4 further outputs a switching signal S1 to the switch 3. Inside the switch 3 at this time, a signal for switching the first switch 31, the third switch 33, and the fifth switch 35 to the switching contact a1 sides, and a signal for switching the contacts of the second switch 32, the fourth switch 34, and the sixth switch 36 to be opened are generated. By these signals, the switching contacts of the first switch 31, the third switch 33, and the fifth switch 35 are switched to the switching contact a1 sides, and the contacts of the second switch 32, the fourth switch 34, and the sixth switch 36 are switched to be opened.

In the connection state illustrated in FIG. 6, the serial-winding electric motor 2 is configured by connecting the U-phase first winding 2au and the U-phase second winding 2bu in series, connecting the V-phase first winding 2av and the V-phase second winding 2bv in series, and connecting the W-phase first winding 2aw and the W-phase second winding 2bw in series. In this connection state, the electric motor 2 is driven only by the inverter 1a. That is, the inverter 1b is electrically disconnected from the electric motor 2.

Alternatively, the controller 4 outputs a switching signal S2 to the switch 3. Inside the switch 3 at this time, a signal for switching the first switch 31, the third switch 33, and the fifth switch 35 to the switching contact b1 sides, and a signal for switching the contacts of the second switch 32, the fourth switch 34, and the sixth switch 36 to be closed are generated. By these signals, the switching contacts of the first switch 31, the third switch 33, and the fifth switch 35 are switched to the switching contact b1 sides, and the contacts of the second switch 32, the fourth switch 34, and the sixth switch 36 are switched to be closed. FIG. 7 is a diagram illustrating the connection state at this time.

In the connection state illustrated in FIG. 7, the electric motor 2 is driven by both of the inverter 1a and the inverter 1b. Specifically, the inverter 1a applies a voltage to the first winding group 2a of the electric motor 2, and the inverter 1b applies a voltage to the second winding group 2b of the electric motor 2. That is, the electric motor 2 is driven by one inverter for each winding group. Thus, the current flowing through the inverter 1a is half of that when only the inverter 1a drives the electric motor 2. Since the system efficiency can be improved when the electric motor 2 is driven by two inverters including the inverter 1b according to the characteristics of the on-state voltage of the switching elements constituting the inverter 1a, using two inverters is suitable for such a case.

In the connection state in FIG. 7, by opening the contacts of the second switch 32, the fourth switch 34, and the sixth switch 36, it is possible to electrically disconnect the inverter 1b from the electric motor 2. In addition, by providing neutral switching contacts in the first switch 31, the third switch 33, and the fifth switch 35 and switching them to the neutral switching contacts, it is possible to electrically disconnect the inverter 1a from the electric motor 2. These connection forms are effective when one of the inverter 1a and the inverter 1b fails and the faulty inverter is disconnected from the electric motor 2 to continue operation using the normal inverter.

As described above, with the electric-motor driving apparatus 100 according to the second embodiment, it is possible to change the winding specification of the electric motor 2 to the serial winding or the parallel winding and to drive the electric motor 2 with a plurality of inverters using the winding group the specification of which is changed. Accordingly, in addition to obtaining the effects of the first embodiment, it is possible to perform control depending on the characteristics of the on-state voltage of the switching elements constituting the inverters and to improve the system efficiency. In addition, since the electric motor 2 can be driven by a plurality of inverters, it is possible to flexibly cope with the requirement for driving the electric motor 2 with a large current.

Furthermore, with the electric-motor driving apparatus 100 according to the second embodiment, the neutral point N of the electric motor 2 can be fixed although the winding specification is changed, and the potential difference at the neutral point N does not occur. Accordingly, although a plurality of inverters are used, it is possible to obtain the effect of relatively easy control of the inverters.

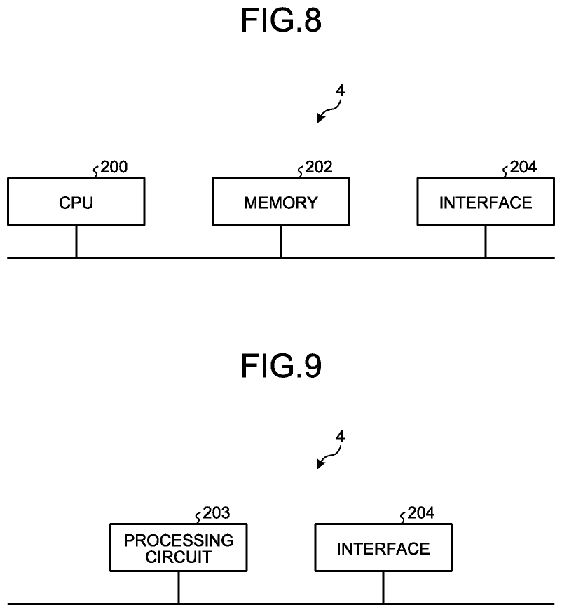

Finally, a hardware configuration to perform the functions of the controller 4 in the first and second embodiments is described with reference to the drawings of FIGS. 8 and 9.

In order to perform the functions of the above controller 4, a Central Processing Unit (CPU) 200 that performs arithmetic operation, a memory 202 that stores a program read by the CPU 200, and an interface 204 that inputs and outputs signals are included as illustrated in FIG. 8. The CPU 200 may be an arithmetic unit such as a microprocessor, a microcomputer, a processor, or a Digital Signal Processor (DSP). The memory 202 is a nonvolatile or volatile semiconductor memory such as a Random Access Memory (RAM), a Read Only Memory (ROM), a flash memory, an Erasable Programmable ROM (EPROM), or an Electrically EPROM (EEPROM).

Specifically, the memory 202 stores a program for performing the function of the controller 4. The CPU 200 exchanges necessary information via the interface 204 to perform arithmetic processing related to the PWM signals Up to Wn and arithmetic processing related to the switching signals S1 and S2 to the switch 3 described in the first embodiment. The CPU 200 further performs arithmetic processing related to the PWM signals Up1 to Wn1 and Up2 to Wn2 and the arithmetic processing related to the switching signals S1 and S2 to the switch 3 described in the second embodiment.

In addition, the CPU 200 and the memory 202 illustrated in FIG. 8 may be replaced with a processing circuit 203 as illustrated in FIG. 9. The processing circuit 203 is a single circuit, a composite circuit, a programmed processor, a parallel programmed processor, an Application Specific Integrated Circuit (ASIC), a Field-Programmable Gate Array (FPGA), or a combination thereof.

Note that, the configurations described in the above embodiments are merely examples of the present invention and can be combined with other known techniques, and a part of the configurations can be omitted or changed without departing from the gist of the present invention.

1-15. (canceled)

16. An electric-motor driving apparatus used to drive an electric motor including three or more winding groups constituting a three-phase winding, the electric-motor driving apparatus comprising:
a switch to switch connection of windings of the three or more winding groups;
at least one inverter to drive the electric motor; and
a controller to control the inverter and the switch, wherein
the switch is configured to switch connections of windings of the three or more winding groups by a serial connection, a parallel connection, or a serial/parallel connection for each phase.

17. The electric-motor driving apparatus according to claim 16, wherein the switch uses:
a single-pole single-throw switch; and
a single-pole double-throw switch.

18. An electric-motor driving apparatus used to drive an electric motor including a plurality of winding groups constituting a three-phase winding, the electric-motor driving apparatus comprising:
a switch to switch connection of windings of the plurality of winding groups;
a plurality of inverters to drive the electric motor; and
a controller to control the plurality of inverters and the switch, wherein the switch uses:
a single-pole single-throw switch; and
a single-pole double-throw switch, wherein
each of the inverters supplies power to the windings, of each phase, of the plurality of winding groups via one of the single-pole single-throw switch and the single-pole double-throw switch.

19. The electric-motor driving apparatus according to claim 18, wherein the switch is operated to connect, in series, the windings of the plurality of winding groups by each phase.

20. The electric-motor driving apparatus according to claim 18, wherein the switch is operated to connect, in parallel, the windings of the plurality of winding groups by each phase.

21. The electric-motor driving apparatus according to claim 16, wherein a connection state of the windings of the winding groups is switched to a different state depending on an operation mode.

22. The electric-motor driving apparatus according to claim 18, wherein a connection state of the windings of the winding groups is switched to a different state depending on an operation mode.

23. The electric-motor driving apparatus according to claim 16, wherein a connection state of the windings of the winding groups is switched to a different state depending on a rotation speed of the electric motor, an inverter frequency, or a modulation rate of the inverter.

24. The electric-motor driving apparatus according to claim 18, wherein a connection state of the windings of the winding groups is switched to a different state depending on a rotation speed of the electric motor, an inverter frequency, or a modulation rate of the inverter.

25. The electric-motor driving apparatus according to claim 23, wherein the windings are changed to be connected in series as the rotation speed decreases, and the windings are changed to be connected in parallel as the rotation speed increases.

26. The electric-motor driving apparatus according to claim 24, wherein the windings are changed to be connected in series as the rotation speed decreases, and the windings are changed to be connected in parallel as the rotation speed increases.

27. The electric-motor driving apparatus according to claim 23, wherein the windings are changed to be connected in series as the inverter frequency decreases, and the windings are changed to be connected in parallel as the inverter frequency increases.

28. The electric-motor driving apparatus according to claim 24, wherein the windings are changed to be connected in series as the inverter frequency decreases, and the windings are changed to be connected in parallel as the inverter frequency increases.

29. The electric-motor driving apparatus according to claim 23, wherein the windings are changed to be connected in series as the modulation rate decreases, and the windings are changed to be connected in parallel as the modulation rate increases.

30. The electric-motor driving apparatus according to claim 24, wherein the windings are changed to be connected in series as the modulation rate decreases, and the windings are changed to be connected in parallel as the modulation rate increases.

31. The electric-motor driving apparatus according to claim 16, wherein the electric motor has one neutral point, and connection of the neutral point is maintained even when connection of the windings is changed.

32. The electric-motor driving apparatus according to claim 18, wherein the electric motor has one neutral point, and connection of the neutral point is maintained even when connection of the windings is changed.

33. The electric-motor driving apparatus according to claim 16, wherein the switch is operated to vary an inductance between lines or a resistance value between lines in the electric motor.

34. The electric-motor driving apparatus according to claim 18, wherein the switch is operated to vary an inductance between lines or a resistance value between lines in the electric motor.

35. The electric-motor driving apparatus according to claim 16, wherein the switch is operated to vary a phase induced voltage or a line induced voltage to be induced in the electric motor.

36. The electric-motor driving apparatus according to claim 18, wherein the switch is operated to vary a phase induced voltage or a line induced voltage to be induced in the electric motor.

37. The electric-motor driving apparatus according to claim 16, wherein a control signal to the switch to change connection of the windings is one signal.

38. The electric-motor driving apparatus according to claim 18, wherein a control signal to the switch to change connection of the windings is one signal.

39. The electric-motor driving apparatus according to claim 16, wherein the switch is a semiconductor relay or a power relay.

40. The electric-motor driving apparatus according to claim 18, wherein the switch is a semiconductor relay or a power relay.

41. A refrigeration cycle apparatus comprising the electric-motor driving apparatus according to claim 16 and the electric motor according to claim 16 mounted as a compressor of a refrigeration cycle.

42. A refrigeration cycle apparatus comprising the electric-motor driving apparatus according to claim 18 and the electric motor according to claim 18 mounted as a compressor of a refrigeration cycle.

43. An air conditioner comprising the refrigeration cycle apparatus according to claim 41.

44. An air conditioner comprising the refrigeration cycle apparatus according to claim 42.
